(19) United States
(12) Patent Application Publication
(10) Pub. No.: US 2018/0198582 A1
(43) Pub. Date: Jul. 12, 2018

(54) Radio Network Node, Wireless Device and Methods Performed Therein

(71) Applicant: Telefonaktiebolaget LM Ericsson (publ), Stockholm (SE)

(72) Inventors: Håkan Andersson, Linköping (SE); Mattias Frenne, Uppsala (SE); Johan Furuskog, Stockholm (SE); Niclas Wiberg, Linköping (SE); Qiang Zhang, Täby (SE)

(21) Appl. No.: 15/531,970

(22) PCT Filed: Mar. 28, 2017
(86) PCT No.: PCT/SE2017/050294

§ 371 Date: May 31, 2017

Related U.S. Application Data
(60) Provisional application No. 62/322,845, filed on Apr. 15, 2016.

(51) Int. Cl. H04L 5/00; H04L 25/02; H04W 72/12

(52) U.S. Cl. CPC H04L 5/0048; H04L 5/0007; H04B 7/0617; H04W 72/121; H04L 25/0226

(57) ABSTRACT

A method performed by a radio network node for receiving reference signals from a wireless device in a wireless communications network is provided, the network node and the wireless device operating in the wireless communications network. The radio network node decides (901) whether reference signals to be sent by the wireless device shall be assigned
(1) according to a first way by assigning the reference signals to channel resources in the same frequency allocation for subsequent Orthogonal Frequency-Division Multiplex, OFDM, symbols, or
(2) according to a second way by assigning reference signals to channel resources in offset frequency allocations for subsequent OFDM symbols.

The radio network node then sends (902) an indication to the wireless device. The indication indicates whether to assign the reference signals according to the decided any one out of the first way and the second way.

### TECHNICAL FIELD

Embodiments herein relate to a radio network node, a wireless device and methods performed therein. In particular, embodiments herein relates to transmitting and receiving reference signals in a wireless communication network.

### BACKGROUND

In a typical wireless communication network, wireless devices, also known as wireless communication devices, mobile stations, stations (STA) and/or user equipments (UE), communicate via a Radio Access Network (RAN) to one or more core networks (CN). The RAN covers a geographical area which is divided into service areas or cell areas, which may also be referred to as a beam or a beam group, with each service area or cell area being served by a radio network node such as a radio access node e.g., a Wi-Fi access point or a radio base station (RBS), which in some networks may also be denoted, for example, a “NodeB” or “eNodeB”. A service area or cell area is a geographical area where radio coverage is provided by the radio network node. The radio network node communicates over an air interface operating on radio frequencies with the wireless device within range of the radio network node.

A Universal Mobile Telecommunications System (UMTS) is a third generation (3G) telecommunication network, which evolved from the second generation (2G) Global System for Mobile Communications (GSM). The UMTS terrestrial radio access network (UTRAN) is essentially a RAN using wideband code division multiple access (WCDMA) and/or High Speed Packet Access (HSPA) for user equipments. In a forum known as the Third Generation Partnership Project (3GPP), telecommunications suppliers propose and agree upon standards for third generation networks, and investigate enhanced data rate and radio capacity. In some RANs, e.g. as in UMTS, several radio network nodes may be connected, e.g., by landlines or microwave, to a controller node, such as a radio network controller (RNC) or a base station controller (BSC), which supervises and coordinates various activities of the plural radio network nodes connected thereto. This type of connection is sometimes referred to as a backhaul connection. The RNCs and BSCs are typically connected to one or more core networks.

Specifications for the Evolved Packet System (EPS), also called a Fourth Generation (4G) network, have been completed within the 3^{rd} Generation Partnership Project (3GPP) and this work continues in the coming 3GPP releases, for example to specify a Fifth Generation (5G) network. The EPS comprises the Evolved Universal Terrestrial Radio Access Network (E-UTRAN), also known as the Long Term Evolution (LTE) radio access network, and the Evolved Packet Core (EPC), also known as System Architecture Evolution (SAE) core network. E-UTRAN/LTE is a variant of a 3GPP radio access network wherein the radio network nodes are directly connected to the EPC core network rather than to RNCs. In general, in E-UTRAN/LTE the functions of an RNC are distributed between the radio network nodes, e.g. eNodeBs in LTE, and the core network. As such, the RAN of an EPS has an essentially “flat” architecture comprising radio network nodes connected directly to one or more core networks, i.e. they are not connected to RNCs. To compensate for that, the E-UTRAN specification defines a direct interface between the radio network nodes, this interface being denoted the X2 interface. EPS is the Evolved 3GPP Packet Switched Domain.

Antenna beamforming is a technique of shaping a transmit or receive antenna pattern into beams. These beams may be used to concentrate the transmitted and received signal energy and/or steer it in specific directions. With the advancements of modern antenna techniques this area is gaining increased attention. Especially within the emerging 5G standard for mobile communication this area receives a lot of focus.

Beam steering, also referred to as beam shaping, is typically achieved by using an array antenna comprising several distinct antenna elements. These may be laid of physically along a 1-dimensional line, or arranged in a 2-dimensional grid. See FIG. 1 for a one-dimensional array.

The actual beam steering is performed by altering the phase and/or amplitude of the signals transmitted from or received at the individual antenna elements so that they are combined constructively in the desired direction. FIG. 1 depicts a classic example where a linear array is used to steer the beam ω^{o} off-axis compared to the orientation of the array. In order for the waveforms from two antennas to superimpose constructively in that direction, the phase rotation difference of the two signals due to the path distance difference Δ must correspond to an integer multiple of 2π. This requirement leads to the expression for the phase angle that is given in FIG. 1, which is a function of steering angle, array element distance, and wavelength, wherein:
Array element distance=d
Beam steering towards ω^{o}
Phase delay required:

$$ϕ = \frac{2 π d \cdot sin ( ω )}{λ}$$

where λ is the wavelength
Typically, d≈λ/2

In a simple transmission system, there may be arranged a radio or radio circuitry adapted to produce a time-domain signal that is fed to a transmit antenna arrangement, which may comprise a plurality of different antenna elements. The conceptually simplest way to implement beam forming is to add a beam forming module between the radio and the antenna, which comprises an arrangement of individually controllable antenna elements, for example an array of some configuration.

The beam forming module may take the time-domain signal from the radio or radio circuitry and may multiplex it over all antenna elements. In order to achieve the desired beam forming, the signals to different antenna elements may each have different phase and/or amplitude, e.g. altered and/or shifted by the beam forming module. This corresponds to complex multiplications if the time-domain samples are also complex.

Note that this approach of creating beam forming/steering produces the same beam, e.g. in terms of spatial dimensions and temporal behavior, for the entire frequency band over which the signal is defined, since it is the time-domain signal that is altered on its way to the different antenna elements. This method is often referred to as “analog beamforming”, although the term “time-domain beamforming” is technically more accurate. An analogue beam forming is depicted in FIG. 2.

An alternative approach for beam forming is to apply phase and amplitude adjustments in the frequency domain. This is often called “digital beam forming”. Refer to FIG. 3 for an illustration of this. As an example, the time/frequency grid of an Orthogonal Frequency-Division Multiplexing (OFDM)-based system is shown, in this case an LTE system. The data to be transmitted is mapped as complex numbers to each subcarrier in an OFDM symbol, which is then transformed to the time-domain via an Inverse Fast Fourier Transform (IFFT), e.g. utilizing a suitably adapted IFFT processing circuitry, before it is passed to the radio or radio circuitry.

To implement beam forming in the frequency domain, individual beam forming modules may be inserted in front of the IFFT or respective circuitry of the individual antenna elements. This may allow access to the individual subcarriers of the frequency bandwidth or carrier frequencies to be transmitted; thus, beam forming adjustments may be applied individually per subcarrier, allowing different beams to be formed for different subcarriers.

Accordingly, beam forming may be made user- and/or channel-specific. If a member of a wireless communication network such as a wireless device, which may also be referred to as a user equipment (UE), is scheduled on a number of resource blocks, the subcarriers in these resource blocks may all be given the adjustments that make them belong to the same beam pointing at this UE and/or member and/or beam forming may be performed such that the subcarriers of the resource blocks assigned to the same member or user equipment essentially form the same beam and/or are subjected to the same alignments of phase and/or amplitude.

The increased flexibility of this approach requires, since the data streams going to the different antenna elements are created in the frequency domain, that individual antenna elements have associated to them their own IFFT processing circuitry and radio circuitry, which means an increase in processing requirement and Hardware (HW) complexity compared to a time-domain beam forming approach. Hence, broadly speaking, the choice between time- or frequency-domain beam forming may be a performance/flexibility vs. processing capacity/complexity trade-off.

In a mobile communication system there is typically some solution for estimating the radio channel properties of the Uplink (UL), i.e., the channel from the UE to the radio network node, also referred to as the eNB. When a UE is not transmitting data on a certain part of the spectrum, or not transmitting at all, the eNB needs to have a way of knowing what the UL channel properties are in order to be able to make good scheduling decisions for upcoming uplink data transmissions.

For example, in LTE this is achieved by having the UE to transmit so-called Sounding Reference Symbols (SRS). These may be transmitted per transmit antenna, on every other subcarrier over the entire bandwidth, but several more spectrum-conservative options also exist where only a smaller subband is sounded in a given OFDM symbol. The location of this smaller subband then hops around in the spectrum with each new transmission of SRS, at later time instances, so that eventually the entire spectrum has been covered after several such transmissions. The most narrow-band option sounds four consecutive PRBs at the same time, but a fairly large number of SRS bandwidth alternatives between this and the full bandwidth exist.

The reason for sounding only a subband may be to leave room for other UEs to also transmit SRS or to concentrate the transmitted energy to a narrower band in order to achieve better coverage. FIG. 4 shows the principle of sounding subbands as it appears in LTE Release 8. A subband may be sounded during the last OFDM symbol of certain subframes, which may appear at a preconfigured periodicity, or be triggered by the eNB.

For example, in LTE the number of Physical Resource Blocks (PRB)s in a 20 MHz carrier defining a bandwidth of a channel is 100 PRBs. By dividing these into 7 subbands of 14 PRBs each, the sounding with sounding signals 100 will cover 98 of the PRBs. In FIG. 4, where traditional subband sounding is depicted, these 14 PRBs are consecutively laid out in the frequency domain and distributed over several subframes.

Different types of signals in UL may be prioritized differently. For example, for prioritizing what is transmitted in UL, the following can be noted regarding LTE. In the case of a special uplink subframe, which is constructed due to a Time-Division Duplex (TDD) DL-to-UL shift, one or several of the first OFDM symbols of the UL subframe is punctured. Hence, no UL transmission of any kind can take place in those symbols.

Physical Random-Access Channel (PRACH) transmission has higher priority than SRS, which means that SRS must not be transmitted on the resources reserved for PRACH.

SRS has higher priority than Physical Uplink Shared Channel (PUSCH), which means that PUSCH must be not be transmitted on re-sources reserved for SRS.

In the context of time-domain, i.e. analog, beamforming it is a problem when the sounding happens over a small subband.

The reason is that since for time-domain beamforming the entire bandwidth is included in the same beam, pointing in one direction. Hence, the eNB can only measure one beam and one subband in one OFDM symbol per beamformed received time-domain signal. To cover all beams and the full bandwidth, many subband transmissions are needed from the UE, which is a problem since it introduces delays in the sounding and it is power consuming for the battery-driven terminal. Moreover, when the UE is non-stationary, the delay may cause the channel estimated from the SRS to be outdated if there is significant delay. An eNB equipped with multiple receive paths, capable of forming individual beams, may receive in multiple, but limited, simultaneous directions at the expense of (HW) complexity and physical footprint.

A typical behavior of the eNB is to sweep the received beam in different directions during the subframe. Hence, each OFDM symbol is received in different beam directions. This means that an SRS from a certain UE may be received in only one, or a very limited number of, OFDM symbols, thus yielding channel information over only a small subband.

The problem is accentuated if also the UE is doing time-domain beamforming transmission, beam-specific SRS, and is sweeping the beam direction of its SRS transmission. Only one or a few of the beams may be picked up by the eNB, which results in incomplete channel state information and increased delay of acquiring channel state information of the uplink channel.

### SUMMARY

An object herein is to improve the performance of a wireless communication network.

According to a first aspect, the object is achieved by example embodiments of a method performed by a radio network node. The network node and the wireless device operate in the wireless communications network. The method may comprise any one or more out of:
Deciding whether reference signals to be sent by the wireless device shall be assigned

according to a first way by assigning the reference signals to channel resources in the same frequency allocation for subsequent Orthogonal Frequency-Division Multiplex OFDM symbols, or

according to a second way by assigning reference signals to channel resources in offset frequency allocations for subsequent OFDM symbols.
Sending an indication to the wireless device, which indication indicates whether to assign the reference signals according to the decided any one out of the first way and the second way
Receiving the reference signals from the wireless device according to the sent indication.

According to a second aspect, the object is achieved by example embodiments of a method performed by a wireless device, for sending reference signals such as SRS, to a radio network node in a wireless communications network.

The network node and the wireless device operate in the wireless communications network. The method may comprise any one or more out of:
Receiving an indication from the radio network node, which indication indicates whether reference signals to be sent by the wireless device shall be assigned:

according to a first way wherein the reference signals shall be assigned to channel resources in the same frequency allocation for subsequent OFDM symbols, or

according to a second way wherein the reference signals shall be assigned to channel resources in offset frequency allocations for subsequent OFDM symbols,
Sending the reference signals to the radio network node assigned according to the indicated way.

According to a third aspect, the object is achieved by example embodiments of radio network node. The network node and the wireless device are operable in the wireless communications network.

The radio network node may be configured to, e.g. by means of a deciding module configured to, decide whether reference signals to be sent by the wireless device 120 shall be assigned

according to a first way by assigning the reference signals to channel resources in the same frequency allocation for subsequent OFDM symbols, or

according to a second way by assigning reference signals to channel resources in offset frequency allocations for subsequent OFDM symbols.

The radio network node may be configured to, e.g. by means of a sending module configured to, send an indication to a wireless device, which indication is adapted to indicate whether to assign the reference signals according to the first way or the second way according to the decision.

The radio network node may be configured to, e.g. by means of a receiving module configured to, receive the reference signals from the wireless device according to the sent indication.

According to a fourth aspect, the object is achieved by example embodiments of a wireless device for receiving a reference signal such as an SRS, from a radio network node in a wireless communications network.

The network node and the wireless device are operable in the wireless communications network.

The wireless device may be configured to, e.g. by means of a receiving module configured to, receive an indication from the radio network node, which indication is adapted to indicate whether reference signals to be sent by the wireless device shall be assigned

according to a first way wherein the reference signals shall be assigned to channel resources in the same frequency allocation for subsequent OFDM symbols, or

according to a second way wherein the reference signals shall be assigned to channel resources in offset frequency allocations for subsequent OFDM symbols.

The wireless device may be configured to, e.g. by means of a sending module configured to, send the reference signals, assigned to channel resources according to the indicated way.

By deciding which of the first and second way, the reference signals to be sent by the wireless device shall be assigned to the channel resources, and by informing the wireless device accordingly, the reference signals can be sent accordingly to the radio network node in a way that is optimal for the radio network node. This may be in terms of ease of co-scheduling PUSCH transmissions from the wireless device or other wireless devices in the same subframe, or maximizing the received SRS energy in a given subband, or evaluating receive beams at the radio network node. Simpler co-scheduling increases the capacity potential of the network. Maximizing received SRS energy enables channel evaluation even in coverage-limited scenarios, and receive-beam evaluation enables the radio network node to utilize the optimal receive beam. In this way the performance of a wireless communication network is improved.

### BRIEF DESCRIPTION OF THE DRAWINGS

Embodiments will now be described in more detail in relation to the enclosed drawings, in which:

FIG. 1 is a schematic block diagram depicting a setup for beam forming according to prior art;

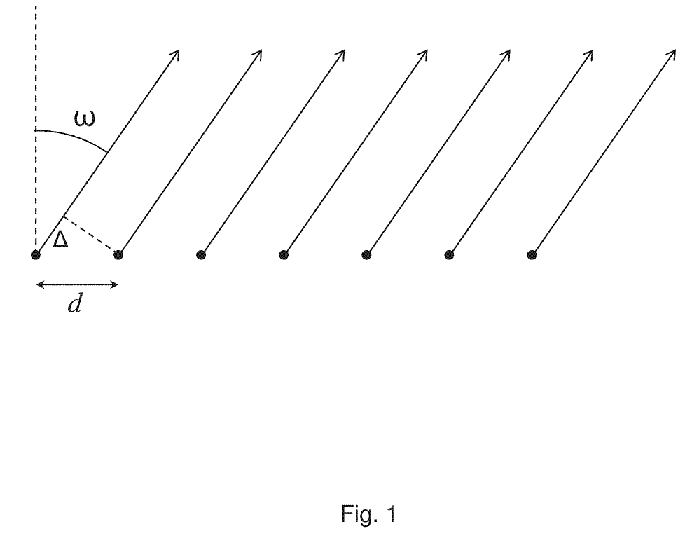

FIG. 2 is a schematic block diagram depicting an example of analogue beam forming according to prior art;

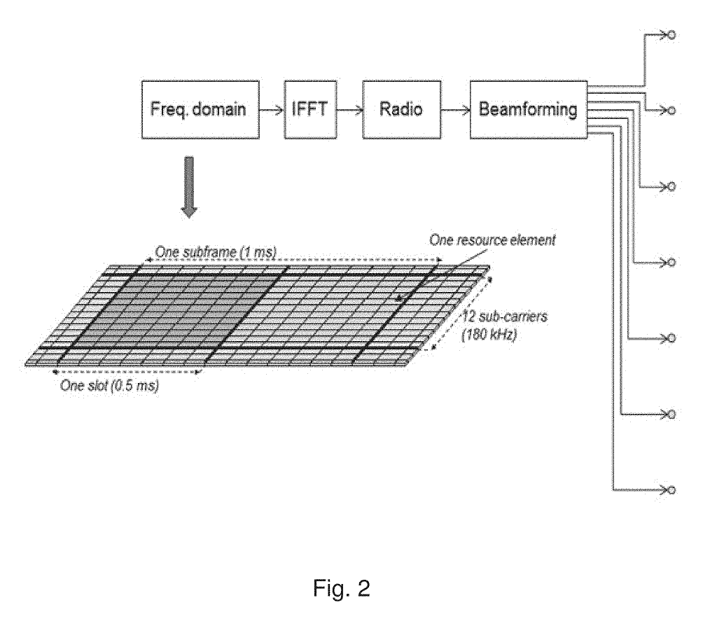

FIG. 3 is a schematic block diagram depicting an example of digital beam forming according to prior art

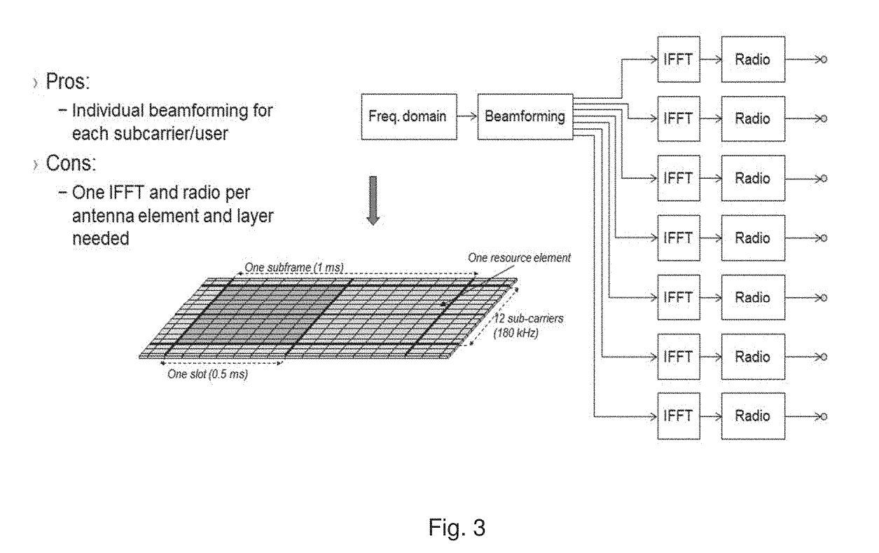

FIG. 4 is a schematic block diagram depicting sounding subbands according to prior art;

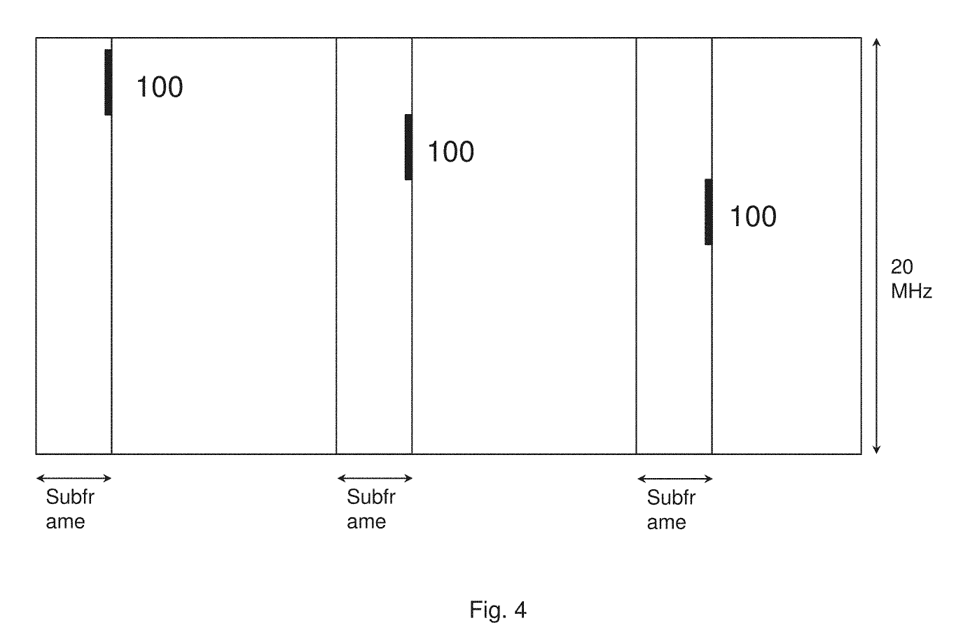

FIG. 5 is a schematic block diagram depicting embodiments of a wireless communications network;

FIG. 6 is a schematic block diagram depicting embodiments of sounding signals in a subframe,

FIG. 7 is a schematic block diagram depicting embodiments of sounding signals in a subframe,

FIG. 8 is a combined flowchart and signalling scheme according to embodiments herein:

FIG. 9 is a flowchart depicting a method performed by a radio network node according to embodiments herein;

FIG. 10 is a flowchart depicting a method performed by a wireless device according to embodiments herein;

FIG. 11 is a schematic block diagram depicting a radio network node according to embodiments herein;

FIG. 12 is a schematic block diagram depicting a wireless device according to embodiments herein;

### DETAILED DESCRIPTION

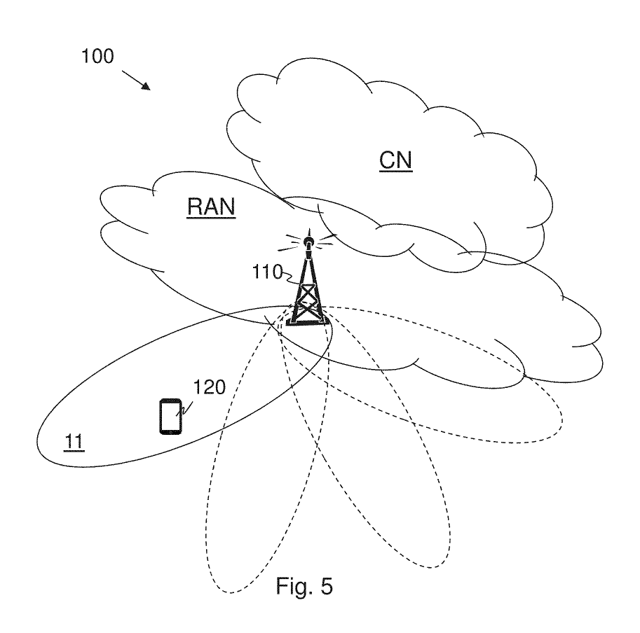

Embodiments herein relate to wireless communication networks in general. FIG. 5 is a schematic overview depicting a wireless communication network 100. The wireless communication network 100 comprises one or more RANs and one or more CNs. The wireless communication network 100 may use a number of different technologies, such as Wi-Fi, Long-Term Evolution (LTE), LTE-Advanced, 5G, New Radio (NR), Wideband Code-Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations. Embodiments herein relate to recent technology trends that are of particular interest in a 5G context, however, embodiments are also applicable in further development of the existing wireless communication systems such as e.g. WCDMA and LTE.

In the wireless communication network 100, wireless devices e.g. a wireless device 120 such as a mobile station, a non-access point (non-AP) STA, a STA, a user equipment and/or a wireless terminals, communicate via one or more Access Networks (AN), e.g. RAN, to one or more core networks (CN). It should be understood by the skilled in the art that “wireless device” is a non-limiting term which means any terminal, wireless communication terminal, user equipment, Machine Type Communication (MTC) device, Device to Device (D2D) terminal, or node e.g. smart phone, laptop, mobile phone, sensor, relay, mobile tablets or even a small base station communicating within a cell.

The wireless communication network 100 comprises a radio network node 110 providing radio coverage over a geographical area, a service area 11, which may also be referred to as a beam or a beam group of a first radio access technology (RAT), such as 5G, LTE, Wi-Fi or similar. The radio network node 110 may be a transmission and reception point e.g. a radio access network node such as a Wireless Local Area Network (WLAN) access point or an Access Point Station (AP STA), an access controller, a base station, e.g. a radio base station such as a NodeB, an evolved Node B (eNB, eNode B), a base transceiver station, a radio remote unit, an Access Point Base Station, a base station router, a transmission arrangement of a radio base station, a stand-alone access point or any other network unit capable of communicating with a wireless device within the service area served by the radio network node 110 depending e.g. on the first radio access technology and terminology used. The radio network node 110 may be referred to as a serving radio network node and communicates with the wireless device 120 with Downlink (DL) transmissions to the wireless device 10 and Uplink (UL) transmissions from the wireless device 120.

Embodiments herein relate to signalling of resource-allocation alternatives for reference signals, such as SRS. An indicator also referred to as the indication is used that indicates whether a first way or a second way should be utilized.

When the first way is indicated, the reference signals shall be assigned to channel resources in the same frequency allocation for subsequent OFDM symbols, also referred to as a “straight” SRS-mapping.

When the second way is indicated, the reference signals shall be assigned to channel resources in offset frequency allocations for subsequent OFDM symbols, also referred to as a “staircase” shape.

This makes it possible for the radio network node 110 to control how the wireless device 120 shall assign the reference signals in order to optimize the usage of the SRS depending on scenario and what information that is sought after. This has the advantage of, e.g., enabling the radio communications network 100 such as the radio network node 110 to configure the SRS in such a way that maximum coverage of the spectrum in the frequency direction is achieved, thus providing channel information of the entire frequency domain, the staircase option, which is also referred to as the second way. Alternatively, when the straight option, which is also referred to as the first way, is used the advantages are that co-scheduling of PUSCH transmissions from the wireless device 120 or other wireless devices is possible using existing scheduling mechanisms for PUSCH, thus increasing network capacity. An additional advantage of the straight option which is the first way is that received energy from several OFDM-symbols may be accumulated as they represent the same subbands, thus enabling channel evaluations in coverage-limited scenarios. Yet another advantage of the straight option which is the first way, is that Receiver (Rx)-beam evaluation at the radio network node 110 may be performed since in relies on using the same transmitted signal in multiple successive OFDM-symbols.

According to embodiments herein, NR may support SRS transmission including configurable frequency hopping since a change between the first way comprising the straight SRS-mapping, and the second way comprising the staircase shape is possible.

As mentioned above, the reference signals may be assigned according to the first way and according to the second way.

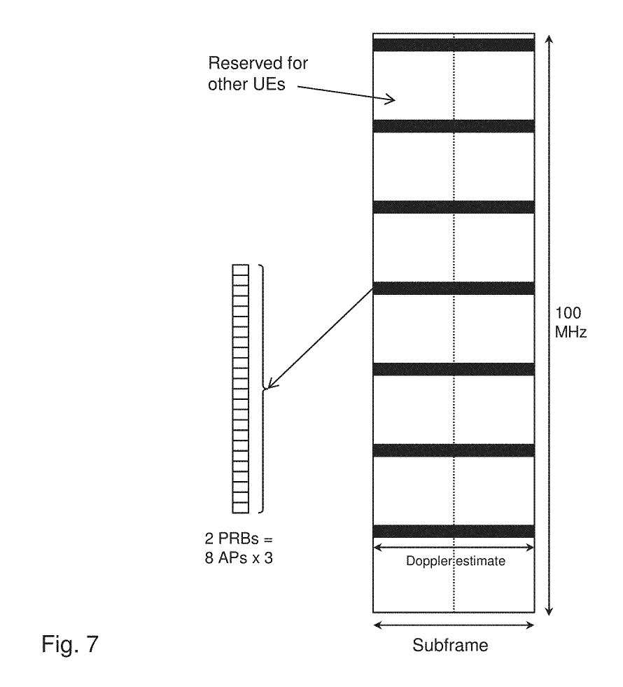

According to the first way, the reference signals shall be assigned to channel resources in the same frequency allocation for subsequent OFDM symbols. This means that the frequency subbands in which the reference signals are transmitted remain the same in all OFDM-symbols throughout the subframe, See FIG. 7 below. The first way may also be referred to as the “straight” option herein.

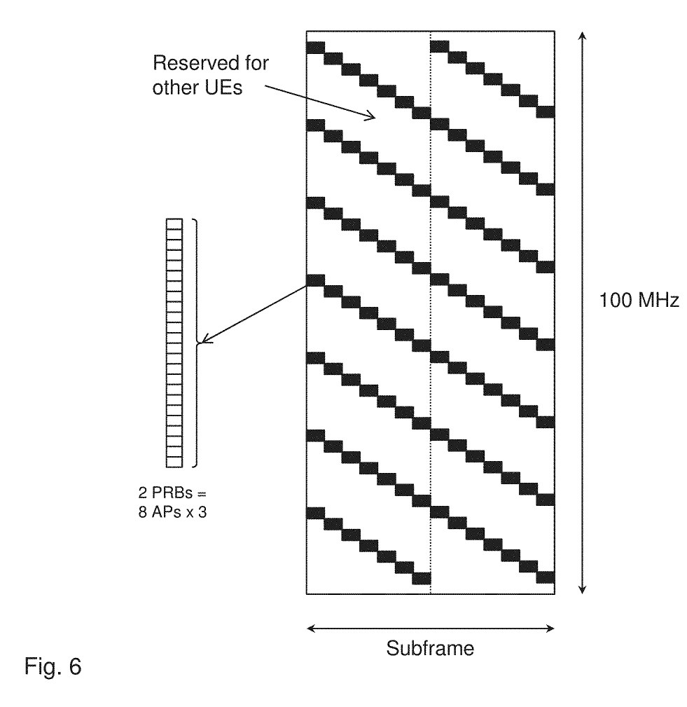

According to the second way, the reference signals shall be assigned to channel resources in offset frequency allocations for subsequent OFDM symbols. This means that the frequency subbands in which the reference signals are transmitted are shifted along the frequency direction between subsequent OFDM-symbols throughout the subframe, See FIG. 6 below. The shifting is performed such that the subband pattern “wraps around” when it reaches the edge of the frequency band. The second way may also be referred to as the “staircase” option herein.

Note that the wording “subsequence OFDM symbols” when used herein shall be interpreted either as
adjacent OFDM symbols within a single multi-symbol SRS transmission, or as
OFDM symbols of subsequent non-adjacent SRS transmissions, each of which may consist of one or more adjacent OFDM symbols.

The second way will be described more in detail below followed by the first way.

The Second Way.

The second way will first be described and is suggested as default or base line today. The sounding signal schedule may be based on a beam forming status and sounding signals, e.g. SRS may be used, that are generally sparsely spread out, and/or are arranged as compact signals, over the entire bandwidth, so that for example a beam may sound and/or sample the entire bandwidth. In this way the need for frequency hopping is reduced, which will lead to shorter channel quality acquisition times and/or more reliable estimates of channel states.

Hence, the eNB such as the network node 110 may obtain channel quality information about the entire UL bandwidth, which may be subsampled, when using beam forming and beam sweeping, in particular in the case of time-domain beam forming. The time to sound the whole channel is shortened, which is useful, particularly in non-stationary channel environments.

The part of the spectrum that is sounded in each OFDM symbol/beam may be spread over almost the entire UL bandwidth. This may be achieved by using a signal layout as depicted in FIG. 6. FIG. 6 shows an example of the second way where the full bandwidth is actually fully sounded in the first slot of the subframe and this is then repeated in the second slot. This model may be referred to as the staircase. In this example:

The utilized bandwidth is 98 PRBs;

14 OFDM-symbols are used;

7 groups of 2 PRBs each spread out over (almost) the entire bandwidth;

8 Antenna Ports, (APs), with 3 Resource Elements (REs) each, are interleaved in each group; An RE is the complex value that can be assigned to a single subcarrier in a single OFDM-symbol, which in turn corresponds to one modulation symbol. An antenna port is a collection of REs that are grouped together such that the reference symbols transmitted over said AP can be used to infer the channel that any data transmitted over the same AP is subjected to.

7 wireless devices such as e.g. one of them being the wireless device 120, may be multiplexed;

Sparse sampling of entire bandwidth in each OFDM-symbol, i.e. beam.
Fits analog beamforming since Transmitter (Tx)/Rx-beams may change between OFDM-symbols.

Doppler estimation is possible, which is necessary to be able to make frequency-error corrections for UEs such as e.g. the wireless device 120, moving at high speed;

Sequence generation is based on UE-ID;

The notation 2 PRBs=8 APs×3 means that each such black block illustrates two Physical Resource Blocks (PRBs), thus consisting of 2×12=24 subcarriers when using LTE as an example since a PRB in LTE comprises 12 subcarriers. Consequently, 8 APs with 3 REs assigned to each will fit precisely in this block.

The First Way

The second way described above is suggested as default or base line today. However, in some situations it would be advantageous to not have the resource mapping in according to the second way, i.e. according to the “staircase” shape as described above, but rather to the first way, i.e. fixed in frequency, see e.g. FIG. 7. According to embodiments herein the radio network node 110 decides whether to assign reference signals according to any one out of the first way and the second way.

The radio network node 110 may e.g. decide that the reference signals shall be assigned according to the first way in the following scenarios.

When SRS shall be utilized for Rx-beam training and/or assessment at the radio network node 110, it is preferred that the wireless device 120 sends the exact same SRS in each OFDM-symbol, i.e. beam, i.e. according to the first way, such that the evaluation of different Rx-beams are comparable at the radio network node 110. If the SRS is shifted in frequency according to the second way, the different Rx-beams will not measure the same signal. When performing Rx-beam evaluation at the radio network node 110 the procedure is that the radio network node 110 receives the SRS from a UE such as the wireless device 120 during one OFDM-symbol on a set of Rx-beams, the set comprising one or several Rx-beams. The radio network node 110 then switches to another set of Rx-beams for the next OFDM-symbol and receives the SRS using this set. The purpose of the evaluation is to find the best Rx-beam, for example where the best signal strength can be received according to some criterion. In order for the comparison between Rx-beam sets to be fair and/or meaningful the SRS transmitted in the different OFDM-symbols shall preferably occupy the same subband(s). If they do not, the received signal does not represent the same part of the spectrum and comparison between Rx-beams is of decreased value.

In a coverage-limited scenario it is beneficial to add the signal from several OFDM-symbols, using the same beams. In this case, the SRS shall preferably be transmitted on the same frequency resources according to the first way.

With the straight SRS resource allocation according to the first way, it is simpler to co-schedule PUSCH from other (or own) UEs in the same subframe.

An example of the first way wherein the reference signals shall be assigned to channel resources in the same frequency allocation for subsequent OFDM symbols is depicted in FIG. 7. Here the width of the system bandwidth, 100 MHz in the example, is depicted and the duration of one subframe. The black stripes correspond to subbands assigned to SRS-transmissions for one particular UE such as the wireless device 120.

In the example of FIG. 7:

The utilized bandwidth is 98 PRBs;

14 OFDM-symbols are used;

7 groups of 2 PRBs each are allocated to 7 subbands of the available bandwidth;

8 APs, with 3 REs each, interleaved in each group;

7 wireless devices such as e.g. one of them being the wireless device 120, may be multiplexed;

Only sampling of 7 subbands in each OFDM-symbol, i.e. beam. The subbands remain the same in all OFDM-symbols.

Doppler estimation is possible. Sequence generation is based on UE-ID. 2 PRBs=8 APs×3 means that each such black stripe illustrates two Physical Resource Blocks (PRBs), thus comprising 2×12=24 subcarriers when using LTE as an example since a PRB in LTE comprises 12 subcarriers. Consequently, 8 APs with 3 REs assigned to each will fit precisely in this block.

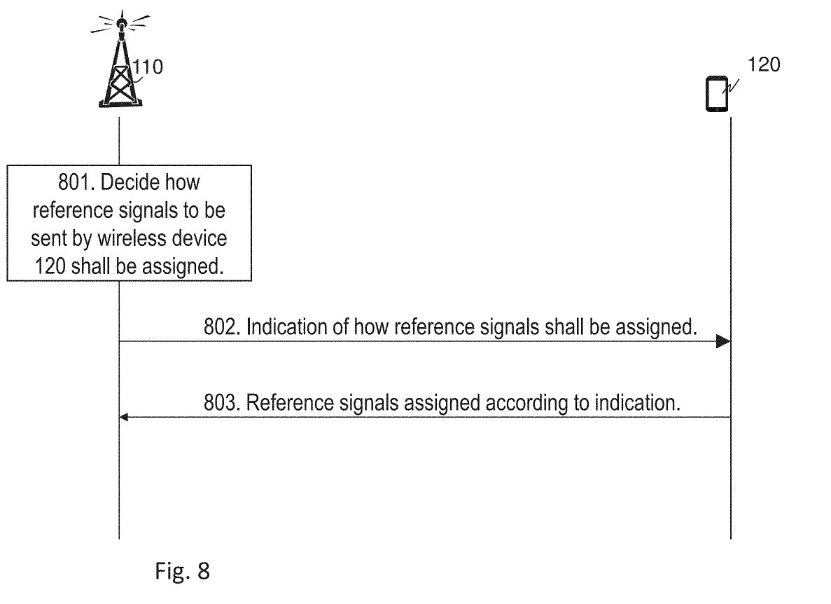

FIG. 8 is a combined flowchart and signalling scheme depicting a method according to an example embodiment herein.

Action 801.

To be able to optimize the usefulness of SRS transmissions, the network node 110 decides how reference signals to be sent by wireless device 120 shall be assigned. That is according to the first way or according to the second way. The network node 110 may decide to assign the reference signals according to the second way in base line cases and in the first way in cases where it is more appropriate to assign channel resources in the same frequency allocation. The first way decision may be performed based on knowledge that a UE, such as the wireless device 120, is coverage limited, that the network such as the radio network node 110 plans to co-schedule PUSCH transmissions from other, or said, wireless device 120 in the same subframe, that the network plans to perform receive-beam training for an eNB, or that the network such as the radio network node 110 plans to obtain a channel estimate over the entire bandwidth for the wireless device 120. This is advantageous since by using the most suitable SRS-configuration superior channel-condition information that can be obtained, the network capacity such as the capacity of the radio network node 110 can be better utilized.

Action 802.

To convey the message of which out of the first and second way the reference signals shall be assigned such as e.g. the SRS-configuration that is assigned, the network node 110 sends an indication to the wireless device 120. This is an indication of how reference signals to be sent by wireless device 120 shall be assigned. This may e.g. be performed by including the indication in the DCI contained in a grant message. The grant message may be a PUSCH grant, a dedicated SRS grant or any other grant type message with a field reserved to convey this information. The indication may also be signaled to the wireless device 120 via higher layer, e.g. RRC, signaling. This is advantageous since both the options of dynamic signaling, via DCIs, and a semi-static option such as RRC-signaling is available, which means that the signaling intensity may be adapted to suit the variability of the network's different needs for information as well as the pace of change of the channel conditions that are measured with the SRS.

Action 803.

To comply with the configuration request from the network such as the radio network node 110, thus using the most suitable SRS-configuration, the wireless device 120 sends the reference signals according to the indication. This is advantageous since the most suitable configuration depends on the objective of the network such as the radio network node 110. For example, in a situation where a UE such as the wireless device 120 is coverage limited, or where overall network utilization requires co-scheduling of PUSCH and SRS, or where receive-beam training for an eNB such as the network node 110 is planned, the first way of sending the SRS may be most suitable. In a situation where channel measurements that sample the entire system bandwidth are desirable, the second way may be preferred.

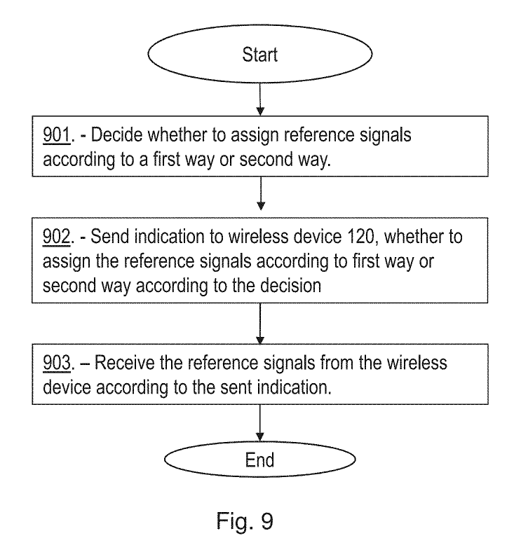

Example embodiments of a method performed by the radio network node 110 e.g. for receiving reference signals from the wireless device 120 in the wireless communications network 100 will now be described with reference to a flowchart depicted in FIG. 9. The network node 110 and the wireless device 120 operate in the wireless communications network 100.

The method may relate to the radio network node 110 managing reference signals such as an SRS.

The method comprises the following actions, which actions may be taken in any suitable order.

Action 901

To be able to optimize the usefulness of SRS transmissions, the network node 110 decides how reference signals to be sent by wireless device 120 shall be assigned. Thus the radio network node 110 decides whether reference signals to be sent by the wireless device 120 shall be assigned

(1) according to a first way by assigning the reference signals to channel resources in the same frequency allocation for subsequent OFDM symbols, or

(2) according to a second way by assigning reference signals to channel resources in offset frequency allocations for subsequent OFDM symbols.

As mentioned above, note that the wording “subsequent OFDM symbols” when used herein shall be interpreted either as adjacent OFDM symbols within a single multi-symbol SRS transmission, or as OFDM symbols of subsequent non-adjacent SRS transmissions, each of which may consist of one or more adjacent OFDM symbols.

The deciding of which way the reference signals shall be assigned may be based on, e.g. the following:

Whether PUSCH transmissions, from the wireless device 120 or other wireless devices, will be co-scheduled in the same subframe. If they will be co-scheduled in the same subframe the radio network node 110 decides that reference signals shall be assigned according to the first way. This has been explained in more detail above.

If the wireless device transmitting SRS is coverage-limited, or if the radio network node plans to perform Rx-beamforming evaluation based on the SRS, the radio network node 110 may also decide that reference signals shall be assigned according to the first way. This has been explained in more detail above.

Thus in some embodiments, the deciding of which way the reference signals shall be assigned is based on any one or more out of:
Whether PUSCH transmissions from the wireless device 120 or other wireless devices will be co-scheduled in the same subframe,
if the wireless device 121 transmitting SRS is coverage-limited, and
if the radio network node 110 plans to perform Rx-beamforming evaluation based on the SRS.

In some embodiments, not only PUSCH, SRS may be co-scheduled with other UL channels as well, e.g. PRACH or PUCCH.

Action 902

The radio network node 110 then needs to inform the wireless device 120 about which of the first and second way it has decided that the reference signals to be sent by the wireless device 120 shall be assigned.

Thus, the radio network node 110 sends an indication to the wireless device 120. The indication indicates whether to assign the reference signals according to the decided any one out of the first way and the second way.

The indication may be conveyed in a grant message such as e.g. an UL Physical Uplink Shared Channel (PUSCH) grant or possibly a dedicated SRS grant. In another embodiment the indicator also referred to as the indication is semi-statically configured using higher-layer signaling. This may e.g. be performed through Radio-Resource Control (RRC) signaling through the exchange of a number of RRC-messages between the radio communications network such as the radio network node and the wireless device. The term indication when used herein is interchangeable to the term indicator.

Accordingly, the indication may e.g. be conveyed in a grant message. In some embodiments, the indication is comprised in a DCI scheduling the reference signal.

The indication may be semi-statically configured using higher-layer signaling.

Action 903

The radio network node 110 may then receive the reference signals from the wireless device 120 according to the sent indication.

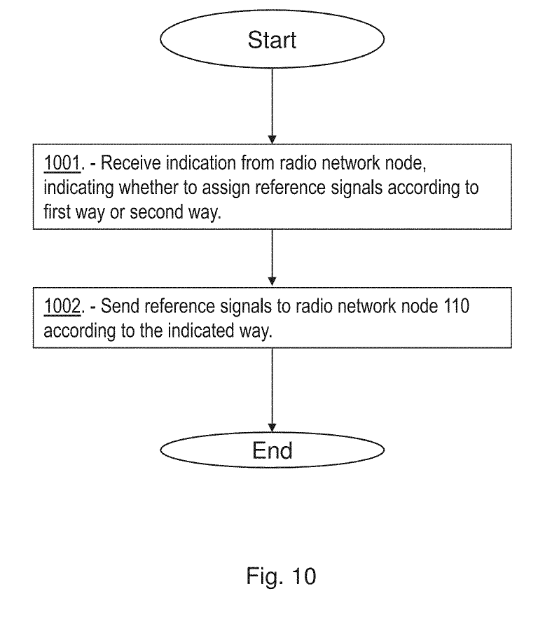

Example embodiments of a method performed by a wireless device 120, for sending reference signals to a radio network node 110 in a wireless communications network 100 will now be described with reference to a flowchart depicted in FIG. 10. The network node 110 and the wireless device 120 operate in the wireless communications network 100. The wireless device may be a user equipment.

The method comprises the following actions, which actions may be taken in any suitable order.

Action 1001

The wireless device 120 receives an indication from the radio network node 110. The indication indicates whether reference signals to be sent by the wireless device 120 shall be assigned

(1) according to a first way, wherein the reference signals shall be assigned to channel resources in the same frequency allocation for subsequent OFDM symbols, or

(2) according to a second way, wherein the reference signals shall be assigned to channel resources in offset frequency allocations for subsequent OFDM symbols.

The indication may be conveyed and received in a grant message. In some embodiments the indicator also referred to as the indication is comprised in a received DCI scheduling the reference signal. The indicator such as the indication may be semi-statically configured using higher-layer signaling.

Action 1002

The wireless device 120 then sends the reference signals to the radio network node 110 assigned according to the received indication.

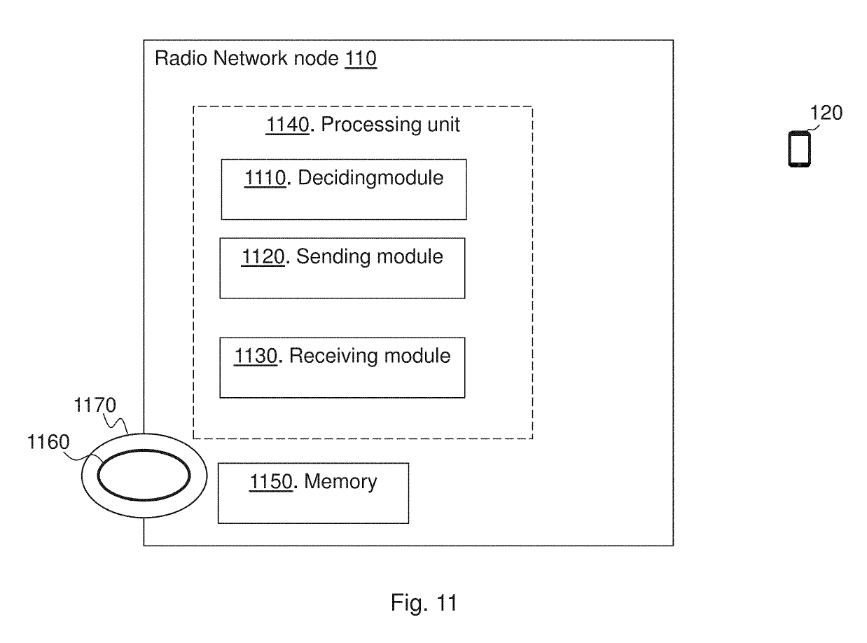

FIG. 11 is a schematic block diagram depicting the radio network node 110. To perform the method actions e.g. for receiving a reference signal such as e.g. an SRS, from the wireless device 120 in a wireless communications network 100, the radio network node 110 may comprise the following arrangement depicted in FIG. 11.

The network node 110 and the wireless device 120 are operable in the wireless communications network 100.

The radio network node 110 may be configured to, e.g. by means of a deciding module 1110 configured to, decide whether reference signals to be sent by the wireless device 120 shall be assigned

according to a first way by assigning the reference signals to channel resources in the same frequency allocation for subsequent OFDM symbols, or

according to a second way by assigning reference signals to channel resources in offset frequency allocations for subsequent OFDM symbols.

The radio network node 110 may be configured to, e.g. by means of a sending module 1120 configured to, send an indication to a wireless device 120, which indication is adapted to indicate whether to assign the reference signals according to the first way or the second way according to the decision. The indication may be conveyable in a grant message such as e.g. an UL PUSCH grant or possibly a dedicated SRS grant. In some embodiment the indicator also referred to as the indication—is to be comprised in a DCI scheduling the reference signal such as the SRS transmission. In another embodiment the indicator such as the indication is to be semi-statically configured using higher-layer signaling.

The radio network node 110 may be configured to, e.g. by means of a receiving module 1130 configured to, receive the reference signals from the wireless device 120 according to the sent indication.

The embodiments herein may be implemented through one or more processors, such as a processing unit 1140 in the radio network node 110 depicted in FIG. 11, together with computer program code for performing the functions and actions of the embodiments herein. The program code mentioned above may also be provided as a computer program product, for instance in the form of a data carrier carrying computer program code for performing the embodiments herein when being loaded into the radio network node 110. One such carrier may be in the form of a CD ROM disc. It is however feasible with other data carriers such as a memory stick. The computer program code may furthermore be provided as pure program code on a server and downloaded to the radio network node 110.

The radio network node 110 may further comprise a memory 1150 comprising one or more memory units. The memory 1150 comprises instructions executable by the processing unit 1140. The memory 1150 is arranged to be used to store e.g. assignments, information, data, configurations, etc. to perform the methods herein when being executed in the radio network node 110.

In some embodiments, a computer program 1160 comprises instructions, which when executed by the at least one processor such as the processing unit 1140, cause the at least one processing unit 1140 to perform actions according to Action 901-903.

In some embodiments, a carrier 1170 comprises the computer program 806, wherein the carrier is one of an electronic signal, an optical signal, an electromagnetic signal, a magnetic signal, an electric signal, a radio signal, a microwave signal, or a computer-readable storage medium.

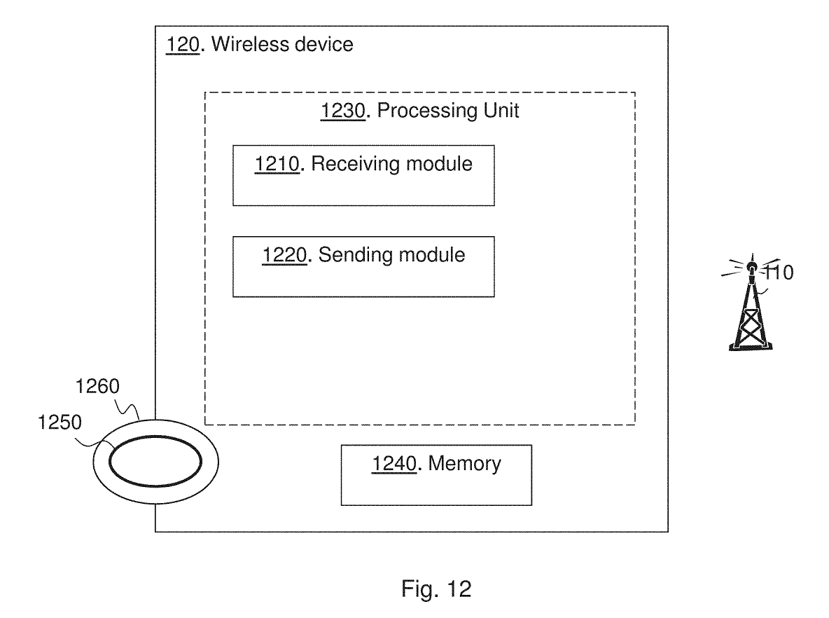

FIG. 12 is a schematic block diagram depicting the wireless device 120. To perform the method actions for receiving a reference signal such as an SRS, from the radio network node 110 in the wireless communications network 100 for processing a control channel from a radio network node 110, the wireless device 120 may comprise the following arrangement depicted in FIG. 12. The network node 110 and the wireless device 120 are operable in the wireless communications network 100. The wireless device 120 may be a user equipment.

The wireless device 120 is configured to, e.g. by means of a receiving module 1210 configured to, receive an indication from the radio network node 110, which indication is adapted to indicate whether reference signals to be sent by the wireless device 120 shall be assigned

according to a first way, wherein the reference signals shall be assigned to channel resources in the same frequency allocation for subsequent OFDM symbols, or

according to a second way, wherein the reference signals shall be assigned to channel resources in offset frequency allocations for subsequent OFDM symbols.

The indicator also referred to as the indication may be conveyable and received in a grant message such as e.g. an UL Physical Uplink Shared Channel (PUSCH) grant or possibly a dedicated SRS grant.

In some embodiments the indication is to be comprised in a received Downlink Control Information (DCI) scheduling the reference signal such as the SRS transmission. In another embodiment the indicator such as the indication is to be semi-statically configured using higher-layer signaling.

The wireless device 120 may be configured to, e.g. by means of a sending module 1220 configured to, send the reference signals, assigned to channel resources according to the received indication.

The embodiments herein may be implemented through one or more processors, such as a processing unit 1230 in the wireless device 120 depicted in FIG. 12, together with computer program code for performing the functions and actions of the embodiments herein. The program code mentioned above may also be provided as a computer program product, for instance in the form of a data carrier carrying computer program code for performing the embodiments herein when being loaded into the wireless device 120. One such carrier may be in the form of a CD ROM disc. It is however feasible with other data carriers such as a memory stick. The computer program code may furthermore be provided as pure program code on a server and downloaded to the wireless device 120.

The wireless device 120 may further comprise a memory 1240 comprising one or more memory units. The memory 1240 comprises instructions executable by the processing unit 1230. The memory 1240 is arranged to be used to store e.g. assignments, priority orders, information, data, configurations, etc. to perform the methods herein when being executed in the wireless device 120.

In some embodiments, a computer program 1250 comprises instructions, which when executed by the at least one processor such as the processing unit 1230, cause the at least one processing unit 1230 to perform actions according to any of the Actions 1001-1002.

In some embodiments, a carrier 1260 comprises the computer program 1250, wherein the carrier is one of an electronic signal, an optical signal, an electromagnetic signal, a magnetic signal, an electric signal, a radio signal, a microwave signal, or a computer-readable storage medium.

The wording “shall be assigned according to a first way by assigning the reference signals to channel resources in the same frequency allocation for subsequent Orthogonal Frequency-Division Multiplex OFDM symbols, or according to a second way by assigning reference signals to channel resources in offset frequency allocations for subsequent OFDM symbols”

may also be referred to as

“shall be assigned according to any one out of: a first way by assigning the reference signals to channel resources in the same frequency allocation for subsequent Orthogonal Frequency-Division Multiplex OFDM symbols, or a second way by assigning reference signals to channel resources in offset frequency allocations for subsequent OFDM symbols.

As will be readily understood by those familiar with communications design, that functions means or modules may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a radio network node, for example.

Alternatively, several of the functional elements of the processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware, read-only memory (ROM) for storing software, random-access memory for storing software and/or program or application data, and non-volatile memory. Other hardware, conventional and/or custom, may also be included. Designers of radio network nodes will appreciate the cost, performance, and maintenance trade-offs inherent in these design choices.

It will be appreciated that the foregoing description and the accompanying drawings represent non-limiting examples of the methods and apparatus taught herein. As such, the apparatus and techniques taught herein are not limited by the foregoing description and accompanying drawings. Instead, the embodiments herein are limited only by the following claims and their legal equivalents.

1-47. (canceled)

48. A method performed by a radio network node, which radio network node and a wireless device operate in a wireless communications network, the method comprising:
deciding whether reference signals to be sent by the wireless device shall be assigned
according to a first way by assigning the reference signals to channel resources in the same frequency allocation for subsequent Orthogonal Frequency-Division Multiplex (OFDM) symbols, or
according to a second way by assigning reference signals to channel resources in offset frequency allocations for subsequent OFDM symbols; and
sending an indication to the wireless device, which indication indicates whether to assign the reference signals according to the decided any one out of the first way and the second way.

49. The method of claim 48, wherein the deciding of which way the reference signals shall be assigned is based on any one or more out of:
whether Physical Uplink Shared Channel (PUSCH) transmissions from the wireless device or other wireless devices will be co-scheduled in the same subframe;
whether the wireless device transmitting Sounding Reference Symbols (SRS) is coverage-limited; and
whether the radio network node plans to perform Rx-beamforming evaluation based on the SRS.

50. The method of claim 48, wherein the indication is conveyed in a grant message.

51. The method of claim 48, wherein the indication is comprised in a Downlink Control Information (DCI) scheduling the reference signals.

52. The method of claim 48, wherein the indication is semi-statically configured using higher-layer signaling.

53. The method of claim 48, further comprising:
receiving the reference signals from the wireless device according to the sent indication.

54. A method performed by a wireless device, for sending reference signals to a radio network node in a wireless communications network, the radio network node and the wireless device operating in the wireless communications network, the method comprising:
receiving an indication from the radio network node, which indication indicates whether reference signals to be sent by the wireless device shall be assigned
according to a first way, wherein the reference signals shall be assigned to channel resources in the same frequency allocation for subsequent OFDM symbols, or
according to a second way, wherein the reference signals shall be assigned to channel resources in offset frequency allocations for subsequent OFDM symbols,
sending the reference signals to the radio network node assigned according to the received indication.

55. The method of claim 54, wherein the indication is conveyed and received in a grant message.

56. The method of claim 54, wherein the indication is comprised in a received Downlink Control Information (DCI) scheduling the reference signal.

57. The method of claim 54, wherein the indication is semi-statically configured using higher-layer signaling.

58. A radio network node, for use with a wireless device in a wireless communications network, the radio network node comprising a processing circuit and a memory comprising instructions executable by the processing circuit whereby the radio network node is configured to:
decide whether reference signals to be sent by the wireless device shall be assigned
according to a first way by assigning the reference signals to channel resources in the same frequency allocation for subsequent Orthogonal Frequency-Division Multiplex (OFDM) symbols, or
according to a second way by assigning reference signals to channel resources in offset frequency allocations for subsequent OFDM symbols; and
send an indication to the wireless device, which indication indicates whether to assign the reference signals according to the decided any one out of the first way and the second way.

59. The radio network node of claim 58, the memory comprising further instructions executable by the processing circuit whereby the radio network node is further configured to decide which way the reference signals shall be assigned based on any one or more out of:
whether Physical Uplink Shared Channel (PUSCH) transmissions from the wireless device or other wireless devices will be co-scheduled in the same subframe,
whether the wireless device transmitting Sounding Reference Symbols (SRS) is coverage-limited, and
whether the radio network node plans to perform Rx-beamforming evaluation based on the SRS.

60. The radio network node of claim 58, wherein the indication is conveyable in a grant message.

61. The radio network node of claim 58, wherein the indication is to be comprised in a Downlink Control Information (DCI) scheduling the reference signal.

62. The radio network node of claim 58, wherein the indication is to be semi-statically configured using higher-layer signaling.

63. The radio network node of claim 58, the memory comprising further instructions executable by the processing circuit whereby the radio network node is further configured to:
receive the reference signals from the wireless device according to the sent indication.

64. A wireless device, for sending reference signals to a radio network node in a wireless communications network, the network node and the wireless device being operable in the wireless communications network, the wireless device comprising a processing circuit and a memory comprising instructions executable by the processing circuit whereby the wireless device is configured to:
receive an indication from the radio network node, which indication indicates whether reference signals to be sent by the wireless device shall be assigned
according to a first way, wherein the reference signals shall be assigned to channel resources in the same frequency allocation for subsequent OFDM symbols, or
according to a second way, wherein the reference signals shall be assigned to channel resources in offset frequency allocations for subsequent OFDM symbols; and
send the reference signals to the radio network node assigned according to the received indication.

65. The wireless device of claim 64, wherein the indication is conveyed and received in a grant message.

66. The wireless device of claim 64, wherein the indication is comprised in a received Downlink Control Information (DCI) scheduling the reference signal.

67. The wireless device of claim 64, wherein the indication is semi-statically configured using higher-layer signaling.

68. The wireless device of claim 64, wherein the wireless device is a user equipment.
